(19) United States
(12) Patent Application Publication
(10) Pub. No.: US 2025/0317891 A1
(43) Pub. Date: Oct. 9, 2025

(54) METHOD, APPARATUS, AND COMMUNICATION SYSTEM FOR PROVISIONING LOCATION-BASED USER EQUIPMENT INFORMATION IN APPLICATION LAYER

(71) Applicant: Electronics and Telecommunications Research Institute, Daejeon (KR)

(72) Inventors: Seung-Ik LEE, Daejeon (KR); Jonghwa YI, Daejeon (KR)

(73) Assignee: Electronics and Telecommunications Research Institute, Daejeon (KR)

(21) Appl. No.: 19/171,579

(22) Filed: Apr. 7, 2025

(30) Foreign Application Priority Data
Apr. 8, 2024 (KR) 10-2024-0047343
Aug. 12, 2024 (KR) 10-2024-0107790
Apr. 1, 2025 (KR) 10-2025-0042213

(51) Int. Cl. H04W 64/00; H04W 4/021; H04W 8/22

(52) U.S. Cl. CPC H04W 64/00; H04W 4/021; H04W 8/22

(57) ABSTRACT

A method of providing location information of the UE within a location area may comprise: receiving, by a Location Management Server (LMS), an information request on the UE within a location area from an application server; determining, by the LMS, information on the UE within the location area using a network function of a core network; and providing, by the LMS, information response on the UE within the location area, which includes information on the communication terminal within the location area, to the application server.

### CROSS-REFERENCE TO RELATED APPLICATIONS

This application claims priority to Korean Patent Applications No. 10-2024-0047343, filed on Apr. 8, 2024, No. 10-2024-0107790, filed on Aug. 12, 2024, and No. 10-2025-0042213, filed on Apr. 1, 2025, with the Korean Intellectual Property Office (KIPO), the entire contents of which are hereby incorporated by reference.

### BACKGROUND

### 1. Technical Field

The present disclosure belongs to a communication technique domain, and more particularly, to a technique for provisioning location-based information of a communication terminal through a communication network.

### 2. Related Art

The content described in this section is provided solely as background information for exemplary embodiments of the present disclosure and does not constitute prior art.

In a wireless communication network, electronic devices such as base stations (BS) and user equipments (UEs) communicate wirelessly to transmit and receive data. Sensing refers to a process of acquiring information on the surroundings of a device. It may also be used to detect various attributes of an object, such as its location, speed, distance, direction, shape, or texture. Such information may be utilized to enhance communication within the network and for other application-specific purposes.

As 5G and 5G Advanced mobile communication technologies enable the development of various converged and integrated fields, the use of location information is steadily increasing and is being recognized as a key resource for application services.

An application server may request, obtain, and utilize the location information of a desired mobile device from a 5G communication network to provide a wide range of public services across daily life.

Location-based services using a 5G communication network primarily rely on cell-based schemes utilizing mobile communication base stations. In the case of micro cells, a resolution within a 1 km radius may be achievable. However, when targeting areas with higher precision than this resolution, it becomes challenging to provide an appropriate location-based service.

Accordingly, there is a growing need for improvements to address such limitations.

### SUMMARY

The present disclosure is intended to address the issues of the prior art, with an objective of providing precise location information of mobile devices within a target area specified by a Vertical Application server (VAL server).

An objective of the present disclosure is to provide a method and procedure to effectively deliver a geofencing location-based service for a target area specified by a VAL server through network functions (NFs) of a 5G network.

An objective of the present disclosure is to rapidly acquire and provide location information of mobile devices within a target area having various shapes as desired by a user, without being limited by coverage of a communication base station or similar limitations.

According to a first exemplary embodiment of the present disclosure, a method of providing location information of a user equipment (UE) within a location area may comprise: receiving, by a Location Management Server (LMS), an information request on the UE within the location area from an application server; determining, by the LMS, information on the UE within the location area using a network function of a core network; and providing, by the LMS, an information response on the UE within the location area, which includes information on the UE within the location area, to the application server.

The information request may include location information of the location area, and the location information of the location area may include information on a geographical area or an application service area for a geofencing service.

The location information of the location area may include information on a shape type of the location area for the geofencing service or geographic coordinates of the location area.

The information response may include an identity/identifier (ID) of the UE within the location area, location information of the UE within the location area, or a list of UEs within the location area.

The determining may comprise: obtaining, by the LMS, the information of the UE within the location area using a Service Capabilities Exposure Function (SCEF) or a Network Exposure Function (NEF) of the core network.

The determining may comprise: obtaining, by the LMS, location information of the UE within the location area using a predetermined Location Management Client (LMC).

The obtaining of the location information of the UE using the predetermined LMC may comprise: retrieving location information of UEs around the LMC.

The determining may comprise: determining the UE within the location area among at least one UE whose location information has been acquired.

The information request may include a request for information on the UE within the location area based on a time condition.

The information response may include information on changes in UEs within the location area over time.

According to a second exemplary embodiment of the present disclosure, an apparatus for providing location information of a user equipment (UE) within a location area may comprise: a computer-readable memory storing at least one instruction; and a processor executing the at least one instruction, wherein the processor may be configured, by executing the at least one instruction, to: receive an information request on the UE within the location area from an application server; determine information on the UE within the location area using a network function of a core network; and provide information response on the UE within the location area, which includes information on the UE within the location area, to the application server.

The information request may include location information of the location area, and the location information of the location area may include information on a geographical area or an application service area for a geofencing service.

The location information of the location area may include information on a shape type of the location area for the geofencing service or geographic coordinates of the location area.

The information response may include an identity/identifier (ID) of the UE within the location area, location information of the UE within the location area, or a list of UEs within the location area.

The processor may be configured to obtain the information of the UE within the location area using a Service Capabilities Exposure Function (SCEF) or a Network Exposure Function (NEF) of the core network.

The processor may be configured to obtain location information of the UE within the location area using a predetermined Location Management Client (LMC).

The processor may be configured to: obtain location information of at least one UE; and determine the UE within the location area among the at least one UE for which the location information has been acquired.

According to a third exemplary embodiment of the present disclosure, a communication network system for providing location information of a user equipment (UE) within a location area may comprise: at least one entity, wherein the at least one entity comprises: a computer-readable memory storing at least one instruction and a processor executing the at least one instruction, and the at least one entity may be configured to: receive, from a Location Management Server (LMS), an information request on the UE within the location area, generated by an application server authenticated or authorized by the LMS; and providing information on the UE within the location area to the LMS using a Service Capabilities Exposure Function (SCEF) or a Network Exposure Function (NEF).

The information request may include location information of the location area, the location information of the location area may include information on a geographical area or an application service area for a geofencing service, a shape type of the location area for the geofencing service, or geographic coordinates of the location area.

The information on the UE within the location area may include an identity/identifier (ID) of the UE within the location area, location information of the UE within the location area, or a list of UEs within the location area.

According to exemplary embodiments of the present disclosure, it is possible to provide high-precision services by acquiring location information of mobile devices within a target area specified by a Vertical Application server (VAL server).

According to exemplary embodiments of the present disclosure, a geofencing location-based service for a target area specified by the VAL server can be effectively provided through network functions (NFs) of a 5G network.

According to exemplary embodiments of the present disclosure, acquisition of location information of mobile devices connected within a target area of various shapes desired by a user is not limited by a coverage of a communication base station or the like, and the related processing time can be reduced, thereby enabling the location information of the mobile devices to be quickly provided to the VAL server.

### BRIEF DESCRIPTION OF DRAWINGS

FIG. 1 is a conceptual diagram illustrating an environment supporting a geofencing location service according to an exemplary embodiment of the present disclosure.

FIG. 2 is a conceptual diagram illustrating a geofencing UE(s) information request/response procedure according to an exemplary embodiment of the present disclosure.

FIG. 3 is a diagram conceptually illustrating a procedure of requesting, acquiring, and responding to geofencing UE(s) information according to an exemplary embodiment of the present disclosure.

FIG. 4 is a conceptual diagram illustrating an example of a generalized computing system in which the VAL server 210, LMS 220, LMC 240, entities within the core network 230, and/or a part thereof are implemented to perform at least part of the processes of FIGS. 1 to 3.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, even if a technology is known prior to the filing date of the present disclosure, it may be included as part of the configuration of the present disclosure when necessary, and will be described herein without obscuring the spirit of the present disclosure. However, in describing the configuration of the present disclosure, a detailed description on matters that can be clearly understood by those skilled in the art as a known technology prior to the filing date of the present disclosure may obscure the purpose of the present disclosure, so excessively detailed description on the known technology will be omitted.

However, the purpose of the disclosure is not to claim the rights to these known technologies, and the contents of the known technologies may be included as part of the disclosure without departing from the scope of the disclosure.

Hereinafter, exemplary embodiments of the disclosure will be described in more detail with reference to the accompanying drawings. To facilitate an overall understanding in the description of the disclosure, the same reference numerals will be assigned to the same components throughout the accompanying drawings, and redundant descriptions thereof will be omitted.

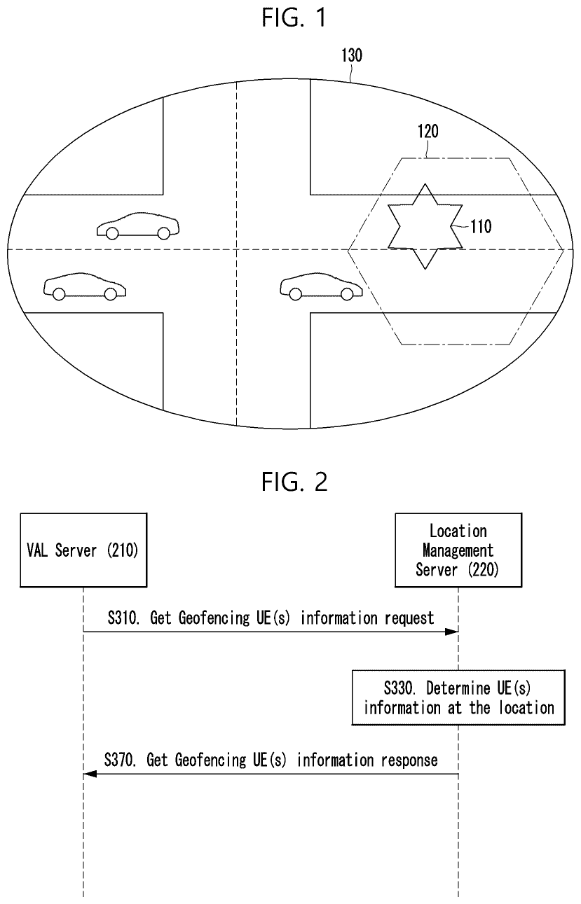

FIG. 1 is a conceptual diagram illustrating an environment supporting a geofencing location service according to an exemplary embodiment of the present disclosure.

A geofencing location service according to an exemplary embodiment of the present disclosure may be provided in various ways, including marketing, advertisement, vehicle safety, home automation, and public disaster alerts.

Geofencing technology can be used to increase service efficiency and improve the accuracy of location information of users or mobile devices.

As shown in FIG. 1, when a traffic accident occurs in a specific area on a road infrastructure 130, or when a disaster such as a sinkhole occurs, an area where the accident or disaster has occurred may be configured as a geofence 110. In addition, as a concept of a conventional technology which is compared with the geofence 110 of FIG. 1, a base station-based cell area 120 is illustrated.

The geofencing location service technology of the present disclosure may be provided in response to the needs of a Vertical Application server (VAL server) desiring to specify a specific area where an accident or disaster has occurred as the geofence 110.

As a comparative example of the present disclosure, the base station-based cell area 120 of the conventional technology may not be configured as a precise location area such as the geofence 110 and has limitations in terms of resolution inherent to the cell area 120.

In order to prevent additional accidents, an accurate area of the geofence 110 needs to be specified. Additionally or alternatively, the presence or precise locations of users or mobile devices within the geofence 110 need to be identified.

The geofencing location service technology according to an exemplary embodiment of the present disclosure may propose an information model defining information on shapes and their coordinates so that the geofence 110 can be specified, identify connected state mobile devices within the geofence 110 by using a network function (NF) or service of a 5G core network, and utilize location information of the identified mobile devices.

The geofencing location service technology according to an exemplary embodiment of the present disclosure may select only the geofence 110 specified according to a request of the VAL server, obtain location information of connected state mobile devices within the geofence 110, and provide customized services.

When the VAL server specifies the geofence 110 using geofencing area information, the geofencing location service technology according to an exemplary embodiment of the present disclosure may obtain location information of user equipments (UEs) within the geofence 110 in a short time from a location management server (LMS), and provide customized services to the UEs in real time.

The geofencing location service technology according to an exemplary embodiment of the present disclosure may propose a method and procedure in which the VAL server utilizes a location service provided by the LMS, which is one of NFs of the 5G network, by using the geofencing location service.

The geofencing location service technology according to an exemplary embodiment of the present disclosure may propose a procedure for requesting and transmitting/receiving necessary information between the VAL server and the LMS of the 5G network.

In the geofencing location service technology according to an exemplary embodiment of the present disclosure, the 5G LMS may request and transmit/receive location information of connected state mobile devices within a specific area (e.g. geofence 110), by using a Network Service Exposure Function (e.g. referred to as ‘SCEF’ or ‘NEF’) provided by the 5G core network.

In the geofencing location service technology according to an exemplary embodiment of the present disclosure, the VAL server may transmit information on a specific location area (e.g. geofence 110) to the 5G LMS. The transmission may be performed using an application programming interface (API) and an information model (or information elements) that represents the specific location area, including its shape—such as a circle, triangle, or polygon—and corresponding coordinates.

In the geofencing location service technology according to an exemplary embodiment of the present disclosure, the 5G LMS may recognize specific geofencing area information requested by the VAL server and may implement a function of acquiring and determining location information of connected state mobile devices within that area (e.g. geofence 110).

In the geofencing location service technology according to an exemplary embodiment of the present disclosure, an API and information model for finally selecting and transmitting the location information of mobile devices acquired by the 5G LMS to the VAL server may be configured or defined. In this case, the 5G LMS may filter and select connected state mobile devices within the geofence 110 among one or more mobile devices, and may provide the location information of the selected mobile devices to the VAL server.

FIG. 2 is a conceptual diagram illustrating a geofencing UE(s) information request/response procedure according to an exemplary embodiment of the present disclosure.

A method for providing location information of a communication terminal (or UE) within a location area according to an exemplary embodiment of the present disclosure may comprise: a step S310 in which an LMS 220 receives an information request on communication terminal(s) within a location area from an application server; a step S330 in which the LMS 220 determines information on communication terminal(s) within the location area by using an NF of a core network 230; and a step S370 in which the LMS 220 provide the application server with a response including information on communication terminal(s) within the location area.

In this case, the location area may correspond to the geofence 110 of FIG. 1.

The application server may be the VAL server 210. The VAL server 210 may be an entity providing an application service offering customized services based on location information.

The VAL server 210 may define a desired specific area (i.e. geofencing area) based on shape(s), and request location information of connected state mobile device(s) or communication terminal(s) (hereinafter, ‘UE(s)’) within the specific area (S310). In this case, the specific area specified by the VAL server 210 may be the geofence 110 of FIG. 1.

The LMS 220 may be an entity providing a function of managing location information of UEs. That is, the LMS 220 may be a server providing a function of managing (registering, storing, retrieving, providing) location information of UEs.

In this case, location information of each UE may be acquired through the 3GPP core network or through a UE registration procedure (S330).

The LMS 220 may provide the VAL server 210 with location information of connected state UEs within the geofencing area in response to the request of the VAL server 210 (S370).

In the step S310 of the method for providing location information on UE(s) within the location area according to an exemplary embodiment of the present disclosure, the VAL server 210 may transmit, to the LMS 220, the geofencing area information in which a specific area, for example, the geofence 110, is represented in various shapes, and may request location information of connected state UEs within the geofence 110 from the LMS 220.

In the method for providing location information on UE(s) within the location area according to an exemplary embodiment of the present disclosure, the information request on UE(s) within the location area provided in the step S310 may include location information of the location area, and the location information of the location area may include information on a geographical area or an application service area for the geofencing service. The information on the application service area may include a VAL service area ID.

The location information may correspond to user-intuitive location information. For example, the location information may refer to a level of location information that can be intuitively understood by users, such as an administrative district, address, or the name of a building or park.

In this case, the location information of the location area may include a shape type of the location area for the geofencing service and/or information on geographical coordinates of the location area.

In the method for providing location information on UE(s) within the location area according to an exemplary embodiment of the present disclosure, information elements that may be included in the information request on UE(s) within the location area provided in the step S310 may be represented as shown in Table 1 and/or Table 2.

TABLE 1

| Information element | Status | Description |
|---|---|---|
| Location information | M | Location information around which the |
| | | UE(s) information is requested |
| | | (e.g., geographic area or |
| | | VAL service area ID). |
| | | The information is also used for |
| | | Geofencing service. |
| >>Shape type | O | It includes the Geofencing |
| | | location area represented |
| | | by different types of shape |
| | | (e.g., polygon or circle) |
| | | as defined in 3GPP |
| | | TS 29.572 [51]. |
| >> Area Coordinates | O | Geographical coordinates of shape as |
| | | defined in 3GPP TS 29.572 [51]. |
| Application defined | M | Description of the range information |
| proximity range | | over which the UE(s) |
| information | | information is required. |

TABLE 2

| Information element | Status | Description |
|---|---|---|
| VAL Server ID | M | Identity of VAL |
| | | Server requesting |
| | | Geofencing UE(s) |
| | | location information. |
| Geofencing filters | M | Geofencing filter specified by |
| | | the vertical application. |
| >Application | M | Area as a geofencing criteria |
| defined area | | |
| information | | |
| (See NOTE) | | |
| >>Geographical area | O | Information representing |
| | | a geographical area |
| | | (e.g., geocode) for which |
| | | the vertical application |
| | | is requesting UE(s) |
| | | location data |
| >>Shape type | O | Geographical area represented using |
| | | various shapes (e.g., circle, polygon) |
| >> Area Coordinate of | O | Geographical coordinate |
| shape | | of shape |

NOTE:
At least one of Geographical area or Shape type should be specified.

Referring to Table 2, VAL Server ID may refer to unique identification information for identifying the VAL server. Geofencing filters may refer to area information. As geofencing filters, a geographical area and/or shape(s) may be selected. In this case, when shape(s) are selected and expressed, a shape type and area coordinates of the shape may be used.

Geofencing filters may be understood as geofencing criteria within a scope not departing from the spirit of the present disclosure. The geofencing filters or geofencing criteria may include geographical area information of a location area represented by a geocode, a polygon, or a circle. The geofencing filters or geofencing criteria may be criteria for identifying and classifying connected state UEs that are located within the location area having a special form such as the geofence 110 in FIG. 1.

In the step S330 of the method for providing location information on UE(s) within the location area according to an exemplary embodiment of the present disclosure, the LMS 220 may verify the validity of the information request and may check whether connected state UEs exist within the location area (e.g. geofence 110) specified by the geofencing area information.

The LMS 220 may identify UEs within the geofence 110 and may acquire or retrieve location information of the UEs.

In the step S330 of the method for providing location information on UE(s) within the location area according to an exemplary embodiment of the present disclosure, the LMS 220 may provide the information of the UEs obtained in the step S330 to the VAL server 210.

In the method for providing location information on UE(s) within the location area according to an exemplary embodiment of the present disclosure, an information response on UE(s) within the location area provided in the step S370 may include an identity/identifier (ID) of each UE within the location area, location information of each UE within the location area, or a list of the UEs within the location area.

In the method for providing location information on UE(s) within the location area according to an exemplary embodiment of the present disclosure, information elements that may be included in the information response on UE(s) within the location area provided in the step S370 may be represented as shown in Table 3.

TABLE 3

| Information element | Status | Description |
|---|---|---|
| List of UE(s) information | O | Identities of UE(s) that |
| | | were detected in a range |
| | | of area requested by the application. |
| | | The list can be empty. |
| >UE ID | M | Identity of VAL UE. |
| >Location information | M | Location information of UE |
| | | within the requested area. |

Referring to Table 3, a UE ID may be included in information elements as unique identification information for identifying each UE. A list of UE(s) information may include UE IDs and location information.

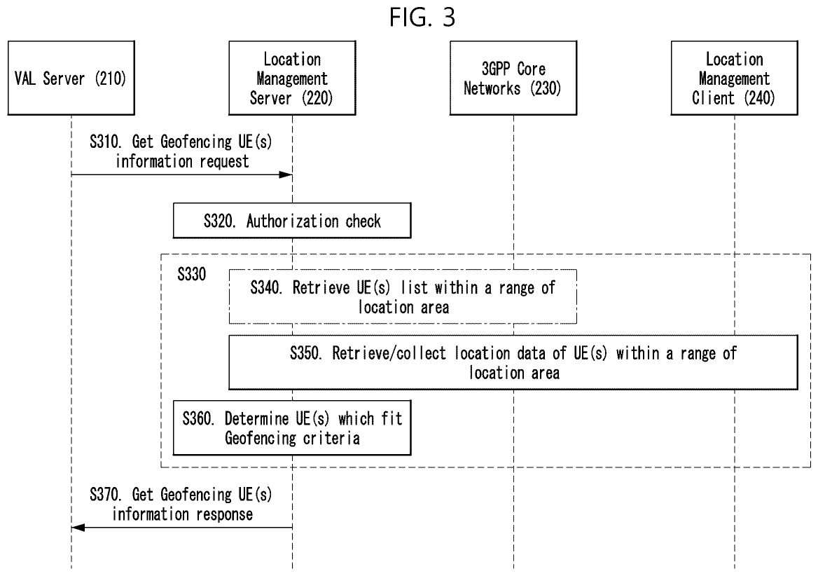

FIG. 3 is a diagram conceptually illustrating a procedure of requesting, acquiring, and responding to geofencing UE(s) information according to an exemplary embodiment of the present disclosure.

The method for providing location information on UE(s) within the location area according to an exemplary embodiment of the present disclosure may comprise: a step S310 in which the LMS 220 receives an information request on UE(s) within a location area (e.g. geofence 110) from an application server; a step S320 in which the LMS 220 authenticates or authorizes a viewing or retrieval right of the application server; a step S330 in which the LMS 220 determine information on UE(s) within the location area by using an NF of the core network 230; a step S370 in which the LMS 220 provides the application server with an information response including information on UE(s) within the location area.

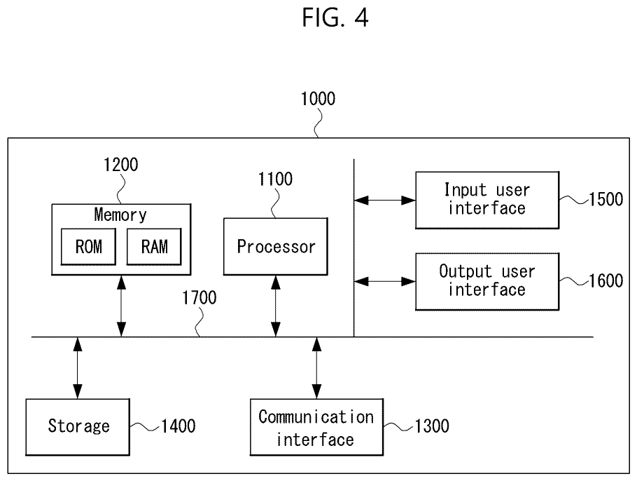

Referring to FIG. 3 and FIG. 4 to be described later, entities within the core network 230 and/or entities related to the location-based service process, according to an exemplary embodiment of the present disclosure, may include a computer-readable memory 1200 storing at least one instruction; and a processor 1100 executing the at least one instruction.

The core network 230 supporting the geofencing location service according to an exemplary embodiment of the present disclosure may include various NFs, and although not illustrated in FIG. 3, may exemplarily include an Application Function (AF), an Access and Mobility management Function (AMF), an Application Service Provider (ASP), a Location Management Function (LMF), a Network Exposure Function (NEF), Operation, Administration, and Maintenance (OAM), a Session Management Function (SMF), a Policy Control Function (PCF), a Unified Data Management (UDM), a Unified Data Repository (UDR), a Data Network (DN) or a local part of a DN that can access the data network locally, a User Plane Function (UPF), a (Radio) Access Network ((R)AN), and a User Equipment (UE).

Here, each NF may support functions below.

The AMF may provide a function for access and mobility management per UE, and one AMF may be connected to each UE by default.

The DN may refer to, for example, an operator service, Internet access, or third-party service. The DN may transmit downlink protocol data units (PDUs) to the UPF or receive uplink PDUs transmitted from a UE via the UPF. A local part of the DN may refer to a portion of the DN that is locally accessible and may represent a data network with a short data transmission path. The local part of the DN may be used to refer to a DN in which an edge application server supporting an edge computing service is deployed.

The PCF may provide a function for receiving information on packet flows from the application server and determining policies for mobility management, session management, and the like. Specifically, the PCF may support functions such as providing a unified policy framework for controlling network operations, providing policy rules so that control plane functions (e.g. AMF, SMF) can enforce policy rules, and implementing a front end for accessing relevant subscription information in the UDR for policy determination.

The SMF may provide a session management function and, when a UE has a plurality of sessions, each session may be managed by a different SMF.

The UDM may store a user's subscription data, policy data, and the like.

The UPF may deliver a downlink PDU received from the DN to a UE via a (R)AN, and may deliver an uplink PDU received from the UE via the (R)AN to the DN. An uplink classifier (ULCL) may refer to a UPF having a function for classifying and transmitting uplink traffic. A local UPF (L-UPF) may perform a role as a PDU session anchor of a session transmitted to the local part of the DN.

A sensing network function (SNF) may be an NF for supporting an Integrated Sensing and Communication (ISAC) service. NFs for supporting the ISAC service may, within a scope not departing from the spirit of the present disclosure, be provided as means for acquiring locations of UEs for the geofencing location service by being combined with the configuration of the present disclosure as needed.

The SNF may perform at least one operation among receiving an ISAC service request, authentication of the request, generation and configuration of a quality control policy for the ISAC service, discovery and selection of network devices and UEs performing sensing operations, and collection and processing of sensing results. These operations may be configured or implemented as two logically separated network functions: a sensing service gateway/center and a sensing management function.

For example, when configured or implemented as logically separated NFs, the sensing service gateway/center may be centrally deployed to receive ISAC service requests, perform authentication operations, and perform operations such as generating ISAC service quality control policies, and the sensing management function may be distributed and locally deployed to perform operations such as discovering and selecting network devices and UEs to perform actual sensing operations, and collecting and processing sensing results. The present disclosure does not limit a method of configuring the sensing network function, and both exemplary embodiments in which the functions are integrated into a single configuration and operate together, and exemplary embodiments in which the functions operate separately are included in the scope of the present disclosure.

The UE may be classified into a UE that actually requests a ISAC service and a UE that serves as a sensor to detect a sensing object for providing the ISAC service in a wireless communication system.

A (R)AN base station forming a radio access network may perform not only signal transmission and reception for communication but also an operation of detecting a sensing object as a sensor.

In order to control a quality of the ISAC service according to an exemplary embodiment of the present disclosure, ISAC service quality information may be used by a wireless communication system and an external ISAC service requesting device. For the sake of description of exemplary embodiments described later, the ISAC service quality-related information may be referred to as a sensing service quality (SSQ).

Referring again to FIG. 3, the core network 230 according to an exemplary embodiment of the present disclosure may communicate with at least one entity that is connectable to a sensing apparatus or sensing device capable of sensing a sensing object (or target). In this case, the sensing device may be a device separate from a UE or a gNB, or may be a UE or a gNB.

The core network 230 may control, manage, or provide configuration information of the sensing device and configuration information of entities which are connected to the sensing device or are sensing devices themselves.

The core network 230 may receive sensing data obtained by the sensing device via the entities which are connected to the sensing device or are sensing devices themselves.

The core network 230 may include a Sensing Entity Control Function (SeCF) 110, a Sensing Entity Management Function (SeMF) 120, a Sensing Result Calculation Function (SeRF) 130, and a Sensing Service Provisioning Function (SePF) 140.

The core network 230 may provide sensing results obtained using the SeCF 110, the SeMF 120, the SeRF 130, and the SePF 140 to an application.

The core network 230 may provide AI/ML, network storage, edge computing, and/or multi-access functions using the SeCF 110, the SeMF 120, the SeRF 130, and the SePF 140.

The operation of the core network 230 illustrated in FIG. 3 may be performed by various NFs within the above-described core network 230. These NFs may be performed by at least one entity within the core network 230, may be performed through cooperation of two or more entities, or may be performed by being assigned to separate entities. The spirit of the present disclosure is not limited by hardware implementation of these NFs within the core network 230.

Referring again to FIG. 3, in the step S320 of the method for providing location information on UE(s) within the location area according to an exemplary embodiment of the present disclosure, the LMS 220 may check whether the VAL server 210, which has transmitted the information request in the step S310, is authorized to use the geofencing location-based UE information service. This process may be referred to as authentication or authorization.

If the VAL server 210 is authorized to use the geofencing location-based UE information service, the step S330 may be performed.

In an alternative exemplary embodiment of the present disclosure, the step S320 may be performed as a part of the step S330.

The step S330 of determining information on UE(s) within the location area may include a step S340 in which the LMS 220 obtains information on UEs within the location area using a Service Capabilities Exposure Function (SCEF) or a Network Exposure Function (NEF) of the core network 230.

In this case, the SCEF or NEF may be performed by at least one entity within the core network 230, and may also be performed through cooperation operations among multiple entities.

That is, in the step S340, the core network 230 may obtain, through the SCEF or NEF, information on connected state UEs within the location area (e.g. geofence 110 of FIG. 1) specified by the request from the VAL server (210).

The step S330 of determining information on UE(s) within the location area may include a step S350 in which the LMS 220 obtains location information of UEs within the location area using a predetermined Location Management Client (LMC) 240.

The step S350 of obtaining the location information of the UE(s) within the location area using the predetermined LMC 240 may include a step of retrieving location information of UEs in the vicinity of the LMC 240.

The LMC 240 may be pre-registered at the core network 230 or at the LMS 220.

The LMC 240 may operate like an application client for the LMF. The LMC 240 may interact with the LMS 220 and may provide UE-based positioning and location-related information. The LMC 240 may support the process of acquiring location information by interacting with another corresponding LMC among two or more UEs.

In an exemplary embodiment of the present disclosure, the location area may be specified to include an area around a predetermined reference UE based on a location of the predetermined reference UE. In this case, the reference UE may be the LMC 240 or may be in a corresponding relationship with the LMC 240.

In another exemplary embodiment of the present disclosure, the LMC 240 may be the VAL server 210 and/or a vertical application server.

The step S330 of determining information on UE(s) within the location area may include a step S360 of determining UE(s) within the location area among at least one UE whose location information has been acquired. In the step S360, the geofencing filters or geofencing criteria disclosed in Table 3 may be used to determine the UE(s) within the location area.

In the method for providing location information on UE(s) within the location area according to an exemplary embodiment of the present disclosure, the information request on UE(s) within the location area may include a request for information on UE(s) within the location area based on a time condition.

In this case, an information response to the information request on UE(s) within the location area may include information on changes in UEs within the location area over time.

In the method for providing location information on UE(s) within the location area according to an exemplary embodiment of the present disclosure, dynamic geofencing UE location information may be provided based on a time condition included in the information request from the VAL server 210.

In this case, the LMS 220 may cooperate with the core network 230 and/or the LMC 240 to obtain information on state changes or location changes of UEs within the location area (i.e. the geofence 110) over time.

The information on UE(s) within the location area (i.e. geofence 110) over time may include information such as a time or time duration when a UE enters the location area (i.e. geofence 110) and a time or time duration when a UE exits the location area (i.e. geofence 110).

For convenience of description, such a request and response for dynamic geofencing UE location information may be referred to as a location area monitoring process. In addition, a request and response for the location area monitoring process may be defined as a location area monitoring subscription procedure.

FIG. 4 is a conceptual diagram illustrating an example of a generalized computing system in which the VAL server 210, LMS 220, LMC 240, entities within the core network 230, and/or a part thereof are implemented to perform at least part of the processes of FIGS. 1 to 3.

In the core network 230 according to exemplary embodiments of the present disclosure, at least a portion of processes, such as sensing, location information acquisition, filtering, computation, data processing, and data transmission and reception, performed by entities executing at least a portion of the NFs, and by entities involved in retrieval of UEs and acquisition of location information of UEs within a target area (i.e. location area) may be executed by the computing system 1000 of FIG. 4.

Referring to FIG. 4, the computing system 1000 according to an exemplary embodiment of the present disclosure may include a processor 1100, a memory 1200, a communication interface 1300, a storage device 1400, an input interface 1500, an output interface 1600, and a bus 1700.

The computing system 1000 according to an exemplary embodiment of the present disclosure may include the at least one processor 1100 and the memory 1200 that stores instructions causing the at least one processor 1100 to perform at least one step. At least a portion of the steps of the method according to an exemplary embodiment of the present disclosure may be performed by the at least one processor 1100 that loads the instructions from the memory 1200 and executes the instructions.

The processor 1100 may refer to a central processing unit (CPU), a graphics processing unit (GPU), or a dedicated processor on which the methods according to the exemplary embodiments of the present disclosure are performed.

Each of the memory 1200 and the storage device 1400 may include at least one of a volatile storage medium and a non-volatile storage medium. For example, the memory 1200 may include at least one of a read-only memory (ROM) and a random access memory (RAM).

The computing system 1000 may further include the communication interface 1300 for performing communication through a wireless network.

The computing system 1000 may further include the storage device 1400, the input interface 1500, and the output interface 1600.

The respective components included in the computing system 1000 may communicate with one another by being connected via the bus 1700.

A location information provision device for UE(s) within a location area according to an exemplary embodiment of the present disclosure may be the LMS 220 illustrated in FIGS. 2 and 3. In addition, a location information provision device for UE(s) within a location area according to an exemplary embodiment of the present disclosure may include the memory 1200 storing at least one computer-readable instruction and the processor 1100 executing the at least one instruction.

The at least one processor 1100 may receive an information request on UE(s) within the location area from an application server (S310), determine information on UE(s) within the location area by using NF(s) of the core network 230 (S330), and provide the application server with an information response on UE(s) within the location area (S370).

In the location information provision device for UE(s) within the location area according to an exemplary embodiment of the present disclosure, the information request on UE(s) within the location area may include location information of the location area, and the location information of the location area may include information on a geographical area or an application service area for a geofencing service.

In the location information provision device for UE(s) within the location area according to an exemplary embodiment of the present disclosure, the location information of the location area may include a shape type of the location area for the geofencing service or geographical coordinate information of the location area.

In the location information provision device for UE(s) within the location area according to an exemplary embodiment of the present disclosure, an information response on UE(s) within the location area may include an ID of each UE within the location area, location information of each UE within the location area, or a list of UEs within the location area.

The processor 1100 may acquire information of the UE(s) within the location area by using the SCEF or NEF of the core network 230 (S340).

The processor 1100 may acquire location information of the UE(s) within the location area by using a predetermined LMC 240 (S350).

The processor 1100 may acquire location information of at least one UE and determine the UE within the location area among the at least one UE whose location information has been acquired (S360).

The communication network system providing location information of UE(s) within the location area according to an exemplary embodiment of the present disclosure may be the core network 230 of FIG. 3.

The communication network system providing location information of UE(s) within the location area according to an exemplary embodiment of the present disclosure may include at least one entity, and the at least one entity may include the memory 1200 storing at least one computer-readable instruction and the processor 1100 executing the at least one instruction.

The at least one entity may receive, from the LMS 220, an information request for UE(s) within a location area generated by an application server authenticated or authorized by the LMS, and may provide information of UE(s) within the location area to the LMS by using the SCEF or NEF (S340).

In the communication network system providing location information of UE(s) within a location area according to an exemplary embodiment of the present disclosure, the information request for UE(s) within the location area may include location information of the location area, and the location information of the location area may include geographical area information or application service area information for a geofencing service, a shape type for the geofencing service of the location area, or geographical coordinate information of the location area.

In the communication network system providing location information of UE(s) within a location area according to an exemplary embodiment of the present disclosure, information of UE(s) within the location area may include each ID of each UE within the location area, location information of each UE within the location area, or a list of UEs within the location area.

An example of the computing system 1000 of the present disclosure may include a communicable desktop computer, laptop computer, notebook, smartphone, tablet PC, mobile phone, smart watch, smart glasses, e-book reader, portable multimedia player (PMP), portable gaming device, navigation device, digital camera, digital multimedia broadcasting (DMB) player, digital audio recorder, digital audio player, digital video recorder, digital video player, or personal digital assistant (PDA), and/or the like.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of providing location information of a user equipment (UE) within a location area, comprising:
receiving, by a Location Management Server (LMS), an information request on the UE within the location area from an application server;
determining, by the LMS, information on the UE within the location area using a network function of a core network; and
providing, by the LMS, an information response on the UE within the location area, which includes information on the UE within the location area, to the application server.

2. The method according to claim 1, wherein the information request includes location information of the location area, and the location information of the location area includes information on a geographical area or an application service area for a geofencing service.

3. The method according to claim 2, wherein the location information of the location area includes information on a shape type of the location area for the geofencing service or geographic coordinates of the location area.

4. The method according to claim 1, wherein the information response includes an identity (ID) of the UE within the location area, location information of the UE within the location area, or a list of UEs within the location area.

5. The method according to claim 1, wherein the determining comprises: obtaining, by the LMS, the information of the UE within the location area using a Service Capabilities Exposure Function (SCEF) or a Network Exposure Function (NEF) of the core network.

6. The method according to claim 1, wherein the determining comprises: obtaining, by the LMS, location information of the UE within the location area using a predetermined Location Management Client (LMC).

7. The method according to claim 6, wherein the obtaining of the location information of the UE using the predetermined LMC comprises: retrieving location information of UEs around the LMC.

8. The method according to claim 1, wherein the determining comprises: determining the UE within the location area among at least one UE whose location information has been acquired.

9. The method according to claim 1, wherein the information request includes a request for information on a UE within the location area based on a time condition.

10. The method according to claim 9, wherein the information response includes information on changes in UEs within the location area over time.

11. An apparatus for providing location information of a user equipment (UE) within a location area, comprising:
a computer-readable memory storing at least one instruction; and
a processor executing the at least one instruction,
wherein the processor is configured, by executing the at least one instruction, to:
receive an information request on the UE within the location area from an application server;
determine information on the UE within the location area using a network function of a core network; and
provide an information response on the UE within the location area, which includes information on the UE within the location area, to the application server.

12. The apparatus according to claim 11, wherein the information request includes location information of the location area, and the location information of the location area includes information on a geographical area or an application service area for a geofencing service.

13. The apparatus according to claim 12, wherein the location information of the location area includes information on a shape type of the location area for the geofencing service or geographic coordinates of the location area.

14. The apparatus according to claim 11, wherein the information response includes an identity (ID) of the UE within the location area, location information of the UE within the location area, or a list of UEs within the location area.

15. The apparatus according to claim 11, wherein the processor is further configured to obtain the information of the UE within the location area using a Service Capabilities Exposure Function (SCEF) or a Network Exposure Function (NEF) of the core network.

16. The apparatus according to claim 11, wherein the processor is further configured to obtain location information of the UE within the location area using a predetermined Location Management Client (LMC).

17. The apparatus according to claim 11, wherein the processor is further configured to:
obtain location information of at least one UE; and
determine the UE within the location area among the at least one UE for which the location information has been acquired.

18. A communication network system for providing location information of a user equipment (UE) within a location area, comprising: at least one entity, wherein the at least one entity comprises:
a computer-readable memory storing at least one instruction; and
a processor executing the at least one instruction,
wherein the at least one entity is configured to:
receive, from a Location Management Server (LMS), an information request on the UE within the location area, generated by an application server authenticated or authorized by the LMS; and
providing information on the UE within the location area to the LMS using a Service Capabilities Exposure Function (SCEF) or a Network Exposure Function (NEF).

19. The communication network system according to claim 18, wherein the information request includes location information of the location area, the location information of the location area includes information on a geographical area or an application service area for a geofencing service, a shape type of the location area for the geofencing service, or geographic coordinates of the location area.

20. The communication network system according to claim 18, wherein the information on the UE within the location area includes an identity (ID) of the UE within the location area, location information of the UE within the location area, or a list of UEs within the location area.
